(19) United States
(12) Patent Application Publication
(10) Pub. No.: US 2009/0190792 A1
(43) Pub. Date: Jul. 30, 2009

(54) Dampening Mechanism for a Micro Speaker

(75) Inventor: Michael Dale Townsend, Durham, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/019,014

(22) Filed: Jan. 24, 2008

(51) Int. Cl. H04R 1/00

(52) U.S. Cl. 381/398

(57) ABSTRACT

A speaker comprises a diaphragm, a drive assembly for producing movement of said diaphragm responsive to an applied electrical signal to generate audible sounds, and at least one mechanical dampener applied to a surface of the speaker to dissipate energy when the dampener is impacted by said diaphragm.

### BACKGROUND

The present invention relates generally to speakers and, more particularly, to a dampening mechanism for a speaker with small dimensions suitable for use in portable electronic devices.

Advances in communication and manufacturing technologies have resulted in mobile devices, such as mobile telephones and personal digital assistants, becoming increasingly smaller in size. One consequence of these size reductions is that less space is available for speakers and other components. While consumers prefer mobile devices with small form factors, consumers still expect high quality audio output from their mobile devices. Therefore, there is great interest among manufacturers in finding ways to reduce the size of speakers while maintaining high quality audio output.

In speakers with a movable diaphragm, the diaphragm needs space to move back and forth. As speakers become smaller, designers must be concerned that the diaphragm will contact the housing or other elements within the speaker at the outer limits of the diaphragm excursion. Contact between the diaphragm and other components in the speaker produces sound distortions which affect the perceived quality of the sound. To avoid this problem, designers often limit the signal level to limit the excursion of the diaphragm. This solution is undesirable because the excursion problem may occur only in a limited band near the resonance frequency of the diaphragm.

### SUMMARY

The present invention relates to a speaker for portable electronic devices, such as cellular telephones, personal digital assistants (PDAs), and audio players. The speaker comprises a diaphragm and a drive assembly to vibrate the diaphragm responsive to an applied electrical signal to produce audible sounds. A mechanical dampener is disposed adjacent to the diaphragm. The mechanical dampener limits the movement of the diaphragm and dampens the impact of the diaphragm to minimize sound distortion. The mechanical dampener may be applied to one or more surfaces of the speaker that are likely to be impacted by the diaphragm.

The mechanical dampener allows the speaker to be operated at a high gain over the entire usable frequency band. For frequencies near the resonance of the diaphragm, where the excursion of the diaphragm is greatest, the diaphragm may contact the mechanical dampener. In this case, the mechanical dampener softens the effect of the impact to minimize sound distortion.

### BRIEF DESCRIPTION OF THE DRAWINGS

FIG. 1 is a cross sectional view of a speaker according to one exemplary embodiment of the invention.

FIG. 2 illustrates an exemplary mobile electronic device including a speaker as shown in FIG. 1.

### DETAILED DESCRIPTION

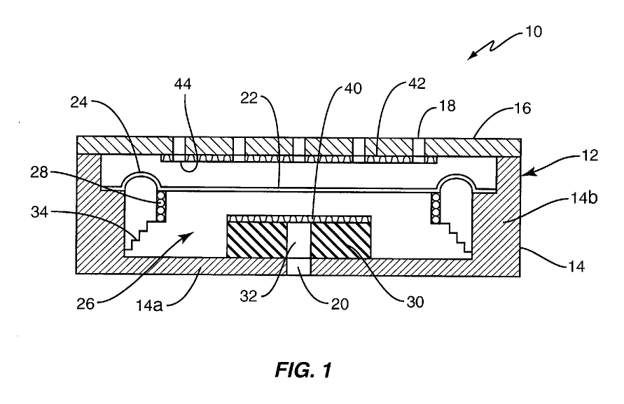

Referring now to the drawings, FIG. 1 illustrates the main elements of a speaker 10 according to one exemplary embodiment of the invention. Speaker 10 comprises a housing 12, a diaphragm 22 that vibrates to produce audible sounds, a suspension member 24 to flexibly suspend the diaphragm 22 within the housing 12, and an electromagnetic drive assembly 26 to produce vibrations of the diaphragm 22 responsive to an applied electrical signal. The electromagnetic drive assembly 26 comprises an electromagnetic coil 28 and magnet 30. The electromagnetic coil 28 connects to the diaphragm 22 and is disposed within a magnetic field generated by the magnet 30. Sound is produced by varying the direction of the current flowing through the electromagnetic coil 28. These current variations cause the electromagnetic coil 28 and diaphragm 22 to move back and forth to generate audible sounds.

The housing 12 of the speaker 10 comprises a frame 14 and a front plate 16. In the exemplary embodiment, the housing 12 encloses the diaphragm 22 and the electromagnetic drive assembly 26. The frame 14 includes a back wall 14a and a side wall 14b. The front plate 16 covers and protects the diaphragm 22.

The magnet 30 mounts to the back wall 14a at the approximate center of the frame 14. The suspension member 24 comprises an elastic ring that is secured at its outer edge to a shoulder formed in the side wall 14b of the frame 14. A spider 34 connects at one end to the frame 14 and at the opposite end to the electromagnetic coil 28. The function of the spider 34 is to provide a restoring force to the diaphragm 22 after the diaphragm 22 is move by the electromagnetic coil 28.

The front plate 16 may include one or more openings 18 to allow air to enter into and exit from the housing 12 on the front side of the diaphragm 22 as the diaphragm 22 moves back and forth. An opening 20 may also be formed in the back wall 14a of the frame 14 to allow air to enter into and exit from the housing 12 on the back side of the diaphragm 22. In the exemplary embodiment shown, the opening 20 aligns with a central opening 32 in the magnet 30. Air on the back side of the diaphragm 22 enters and exits the housing 12 on the back side of the diaphragm 22 though the central opening 32 in the magnet 30.

The speaker 10 illustrated in FIG. 1 may be used in cellular telephones, personal digital assistants, audio playback devices, and other small electronic devices. The magnet 30 is large relative to the size of the entire speaker assembly, and the coil 28 is disposed at the outer edge of the diaphragm 22. This design accommodates a larger diaphragm 22 and stronger magnet 30. The larger diaphragm 22 provides a larger vibrating surface area and therefore greater sensitivity. The stiffness of the diaphragm 22 may be increased to reduce the possibility of unstable vibration modes that could reduce the efficiency and increase the distortion level of the speaker 10. Using a stiff diaphragm 22 also reduces the travel distance of the diaphragm 22.

For use in small electronic devices, it is generally desirable to make the speaker 10 as small as possible. For example, in order to provide a thin profile speaker, the depth of the speaker cavity is typically made as small as possible. Reducing the depth of the speaker cavity may lead to problems when the speaker 10 is operated at maximum sound pressure level. The diaphragm 22 needs space to move back and forth. When this space is small, the diaphragm 22 may come into contact the top of the magnet 30 or the front plate 16 at the outer limits of its excursion. This problem typically occurs in frequency bands near the resonance frequency of the diaphragm 22. Contact between the diaphragm 22 and these other components may produce a perceptible distortion in the sound.

According to one exemplary embodiment of the invention, dampeners 40, 42 may be applied to the top of the magnet 30 and to the inner surface of the front plate 16 to cushion the impact of the diaphragm 22 against the magnet 30 and front plate 16. The thickness, density, porosity, and hardness of the dampeners 40, 42 may be chosen for a preferred trade-off between total component thickness, transducer sensitivity, and sound quality. One material suitable for use as a dampener with the present invention comprises a microcellular urethane foam material such as PORON®. The dampeners 40, 42 may be formed in sheets that are applied to the inside of the front plate 16 and the top of the magnet 30. The dampeners 40, 42 may be secured by a suitable adhesive.

Dampeners 40, 42 allow the speaker 10 to be operated at a high gain over the entire usable frequency band. For frequencies near the resonance of the diaphragm 22, where the excursion of the diaphragm 22 is greatest, the diaphragm 22 may contact the dampeners 40, 42 on the front plate 16 and/or magnet 30. The dampeners 40, 42, in effect, act like shock absorbers to dampen the impact of the diaphragm 22 when the dampener 40, 42 is contacted by the diaphragm 22 and to reduce the amount of sound distortion.

In one embodiment of the invention, the dampener 42 on the front plate 16 may be provided with apertures 44 that align with the sound apertures 18 in the front plate 16 to allow the passage of air as the diaphragm 22 moves back and forth. The dampening material 40 applied to the top of the magnet 30 may cover or partially cover the exit opening in the center of the magnet 30 to restrict the air flow into and out of the housing 12. Restricting the air flow provides a mechanism for tuning the speaker assembly.

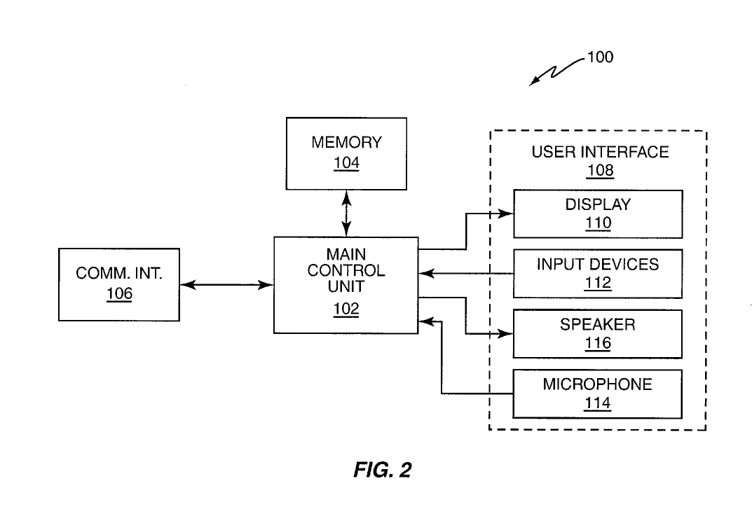

The speaker 10 may be made with a thin profile, making it suitable for use in cellular telephones, personal digital assistants, laptop computer, and other portable and hand-held electronic devices. FIG. 2 illustrates an exemplary mobile electronic device 100 in which the speaker 10 may be used. The mobile electronic device 100 comprises a main control unit 102, memory 104, communication interface 106, and user interface 108. The main control unit 102 may comprise one or more processors to control overall operation of the mobile electronic device 100. Memory 104 stores programs and data needed for operation. Communication interface 106 enables the mobile electronic device 100 to communicate with external devices. The communications interface 106 may comprise for example, a cellular transceiver (e.g., GSM, WCDMA, etc.), wireless LAN (e.g., WiFi, WiMAX, etc.) interface, BLUETOOTH interface, other type of wireless interface. The user interface 108 comprises a display 110, one or more user input device 112, a microphone 114, and speaker 116. The display 110 displays information or viewing by a user. The user input devices 112, such as a keypad, touch pad, joystick, etc., enable the user to input data and commands to control the mobile electronic device 100. The microphone 114 converts audible sounds into electrical signals for input top the main control unit 102. The speaker 116 converts electrical signals into audible sounds that may be heard by the user. Those skilled in the art will appreciate that the speaker 116 may comprise a speaker 10 as shown in FIG. 1.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A speaker comprising:
a diaphragm;
a drive assembly for producing movement of said diaphragm responsive to an applied electrical signal to generate audible sounds; and
at least one mechanical dampener arranged to be contacted by the diaphragm at the outer limits of the diaphragm excursion to dampen the impact of said diaphragm and to reduce sound distortion.

2. The speaker of claim 1 further comprising a housing, wherein a first dampener is applied to a surface of said housing.

3. The speaker of claim 2 wherein said housing includes a front plate, said dampener being applied to an inner surface of said front plate.

4. The speaker of claim 3 wherein said dampener includes one or more apertures to allow to passage of air through the dampener.

5. The speaker of claim 3 wherein the drive assembly comprises an electromagnetic coil attached to said diaphragm and a magnet, wherein a second dampener is applied to a surface of said magnet.

6. The speaker of claim 5 wherein said magnet includes a central opening to allow air to enter into and exit from said housing, and wherein said dampener at least partially covers said opening to restrict air flow through said central opening in said magnet.

7. The speaker of claim 1 wherein the drive assembly comprises an electromagnetic coil attached to said diaphragm and a magnet, wherein a first dampener is applied to a surface of said magnet.

8. The speaker of claim 7 wherein said magnet includes a central opening, and wherein said dampener at least partially covers said central opening in said magnet to restrict air flow through said central opening in said magnet.
